(19) United States
(12) Patent Application Publication
(10) Pub. No.: US 2018/0189655 A1
(43) Pub. Date: Jul. 5, 2018

(54) DATA META-SCALING APPARATUS AND METHOD FOR CONTINUOUS LEARNING

(71) Applicant: Electronics and Telecommunications Research Institute, Daejeon (KR)

(72) Inventors: Se Won OH, Daejeon (KR); Yeon Hee Lee, Daejeon (KR); Ji Hoon Bae, Sejong-si (KR); Hyun Joong Kang, Jinju-si (KR); Soon Hyun Kwon, Incheon (KR); Kwi Hoon Kim, Daejeon (KR); Young Min Kim, Daejeon (KR); Eun Joo Kim, Daejeon (KR); Hyun Jae Kim, Incheon (KR); Hong Kyu Park, Daejeon (KR); Jae Hak Yu, Daejeon (KR); Ho Sung Lee, Daejeon (KR); Seong Ik Cho, Daejeon (KR); Nae Soo Kim, Daejeon (KR); Sun Jin Kim, Daejeon (KR); Cheol Sig Pyo, Sejong-si (KR)

(73) Assignee: Electronics and Telecommunications Research Institute, Daejeon (KR)

(21) Appl. No.: 15/854,387

(22) Filed: Dec. 26, 2017

(30) Foreign Application Priority Data
Jan. 3, 2017 (KR) 10-2017-0000690
Dec. 22, 2017 (KR) 10-2017-0177880

(51) Int. Cl. G06N 5/02; G06F 15/18; G06F 7/02; G06F 17/17

(52) U.S. Cl. CPC G06N 5/02; G06F 17/17; G06F 7/023; G06F 15/18

(57) ABSTRACT

Provided is a data meta-scaling method. The data meta-scaling method optimizes an abbreviation criterion for abbreviating data through continuous knowledge augmentation in various dimensions which enable expression of data in a process of performing machine learning.

### CROSS-REFERENCE TO RELATED APPLICATIONS

This application claims priority under 35 U.S.C. § 119 to Korean Patent Application No. 10-2017-0000690, filed on Jan. 3, 2017 and Korean Patent Application No. 10-2017-0177880, filed on Dec. 22, 2017, the disclosure of which is incorporated herein by reference in its entirety.

### TECHNICAL FIELD

The present invention relates to a data meta-scaling apparatus and method for continuous learning, and more particularly, to technology for processing input data used for learning of a machine learning model.

### BACKGROUND

Machine learning (ML) is being widely used for classifying collected data or learning a model representing a characteristic of the collected data. In association with the ML, various technologies are being developed, and in order to obtain optimal classification performance or learning performance in the ML, the collected data may be appropriately abbreviated or learned based on a machine learning algorithm or a target to obtain rather than using the collected data as-is. That is, in an environment where massive data is continuously collected through various objects, it is very important to control a machine learning system so as to learn data which is appropriately abbreviated based on the purpose of using data or an ambient environment. However, development of a machine learning system for performing a learning process based on appropriately abbreviated data is incomplete up to date.

### SUMMARY

Accordingly, the present invention provides a data meta-scaling apparatus and method for continuous learning, which automate optimization of an abbreviation criterion for abbreviating data through continuous knowledge augmentation in various dimensions which enable expression of data in a process of performing ML.

In one general aspect, a data meta-scaling method for continuous learning includes: setting, by a processor, abbreviation criterion information which defines a rule for abbreviating input data to be expressed in another attribute, learning criterion information which defines a rule for limiting learning on the abbreviation data and a rule for evaluating learning performance, and knowledge augmentation criterion information which defines a rule for optimizing the abbreviation criterion information; abbreviating, by the processor, the input data to abbreviation data, based on the abbreviation criterion information; performing, by the processor, learning on the abbreviation data to generate a learning model, based on the learning criterion information; evaluating, by the processor, performance of the learning model to determine suitability of the abbreviation data, based on the learning criterion information; and performing, by the processor, knowledge augmentation for updating the abbreviation criterion information according to a result of the suitability determination, based on the knowledge augmentation criterion information.

In another general aspect, a data meta-scaling apparatus for continuous learning includes: a meta-optimizer setting abbreviation criterion information which defines a rule for abbreviating input data to be expressed in another attribute, learning criterion information which defines a rule for limiting learning on the abbreviation data and a rule for evaluating learning performance, and knowledge augmentation criterion information which defines a rule for optimizing the abbreviation criterion information; an abbreviator abbreviating the input data to abbreviation data, based on the abbreviation criterion information; a learning machine performing learning on the abbreviation data to generate a learning model, based on the learning criterion information; and an evaluator evaluating performance of the learning model to determine suitability of the abbreviation data, based on the learning criterion information, wherein the meta-optimizer performs knowledge augmentation for updating the abbreviation criterion information according to a result of the suitability determination, based on the knowledge augmentation criterion information.

Other features and aspects will be apparent from the following detailed description, the drawings, and the claims.

### BRIEF DESCRIPTION OF THE DRAWINGS

FIG. 1 is a block diagram illustrating a data meta-scaling apparatus for continuous learning according to a first embodiment of the present invention.

FIG. 2 is a flowchart illustrating a data meta-scaling method for continuous learning according to a first embodiment of the present invention.

FIGS. 3A to 3C are diagrams for describing single dimension-based sampling in data abbreviation according to an embodiment of the present invention.

FIG. 4 is a diagram for describing multi-dimension-based sampling in data abbreviation according to an embodiment of the present invention.

FIG. 5 is a diagram for describing multi-dimension-based sampling in data abbreviation according to another embodiment of the present invention.

FIGS. 6A to 6C are diagrams illustrating data structures of abbreviation criterion information, learning criterion information, and knowledge augmentation criterion information included in schema information according to another embodiment of the present invention.

FIG. 7 is a diagram illustrating an example where schema information according to another embodiment of the present invention is expressed as ontology.

FIG. 8 is a block diagram illustrating a data meta-scaling apparatus for continuous learning according to a second embodiment of the present invention.

FIG. 9 is a block diagram illustrating a data meta-scaling apparatus for continuous learning according to a third embodiment of the present invention.

FIG. 10 is a diagram for describing an example where the data meta-scaling apparatus illustrated in FIG. 1 is applied to a traffic information prediction scenario.

FIGS. 11A to 11C are diagrams schematically illustrating a knowledge augmentation process of obtaining an optimal abbreviation criterion according to an embodiment of the present invention.

### DETAILED DESCRIPTION OF EMBODIMENTS

Hereinafter, embodiments of the present invention will be described in detail with reference to the accompanying drawings. Terms used herein are terms that have been selected in consideration of functions in embodiments, and the meanings of the terms may be altered according to the intent of a user or operator, or conventional practice. Therefore, the meanings of terms used in the below-described embodiments confirm to definitions when defined specifically in the specification, but when there is no detailed definition, the terms should be construed as meanings known to those skilled in the art.

The invention may have diverse modified embodiments, and thus, example embodiments are illustrated in the drawings and are described in the detailed description of the invention. However, this does not limit the invention within specific embodiments and it should be understood that the invention covers all the modifications, equivalents, and replacements within the idea and technical scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A configuration and a function of a data meta-scaling apparatus and method for continuous learning according to an embodiment of the present invention may be implemented with a program module including one or more computer-readable commands.

The program module may be stored in a recording medium such as a memory or the like, and then, may be loaded and executed by a processor to perform a specific function described herein.

The computer-readable commands may include, for example, data and a command which allows a general-use computer system or a special-purpose computer system to perform a specific function or a group of functions.

A computer-executable command may be, for example, an assembly language or a binary or intermediate format command such as a source code. That is, the data meta-scaling apparatus and method for continuous learning according to an embodiment of the present invention may be implemented with software including a computer program, hardware including a memory and a processor like a computer system, or a combination of the hardware and the software which is installed in and executed by the hardware.

A computer program for executing the method according to an embodiment of the present invention may be written in an arbitrary form of a programming language including a transcendental or procedural language or a compiled or construed language, and may be implemented in an arbitrary form including an independent program or module, a component, a subroutine, or another unit appropriate for use in a computer environment.

The computer program does not necessarily correspond to a file of a file system. A program may be stored in a single file provided to a requested program, a multi interaction file (for example, a file storing one or more modules, a subprogram, or a portion of a code), or a portion (for example, one or more scripts stored in a markup language document) of a file retaining another program or data.

Furthermore, the computer program may be configured to be executed by a multicomputer or one or more computers which is located on one site or distributed on a plurality of sites, and are connected to one another over a network.

A computer-readable medium suitable for storing a computer program may include, for example, a semiconductor memory device such as erasable programmable read only memory (EPROM), electrical erasable programmable read only memory (EEPROM), or a flash memory device, for example, a magnetic disk such as an internal hard disk or an external disk, and all types of non-volatile memories, mediums, and memory devices such as a magnetic optical disk, a CD-ROM disk, and a DVD-ROM disk, a medium, and a memory device. A processor and a memory may be complemented by or integrated into a special-purpose logic circuit.

Moreover, the data meta-scaling apparatus and method for continuous learning according to an embodiment of the present invention may be applied to a machine learning system, and in a process of performing ML, may set abbreviation criterion information for input data expressible as a plurality of attributes, based on schema information.

Therefore, the data meta-scaling apparatus and method for continuous learning according to an embodiment of the present invention may perform learning on abbreviated data and may evaluate the abbreviated data by using a result of the learning, thereby providing abbreviation data which enables the optimal performance of ML to be obtained.

Elements and operations according to various embodiments of the present invention will be described.

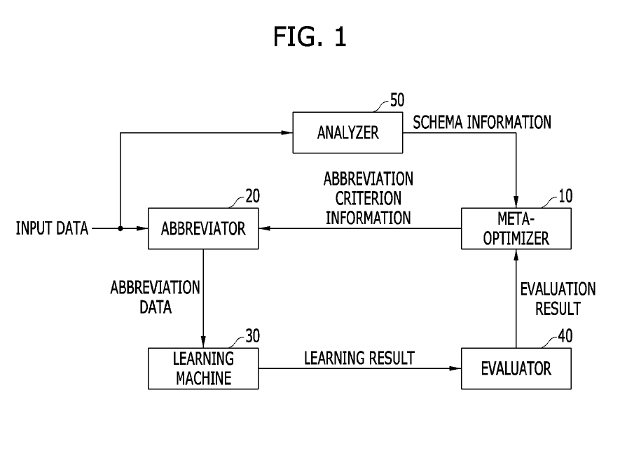

FIG. 1 is a block diagram illustrating a data meta-scaling apparatus for continuous learning according to a first embodiment of the present invention.

The data meta-scaling apparatus according to the first embodiment of the present invention may perform a process of automating an input of data, extraction of schema information, abbreviation of data, learning of a model, storing of a learning history, an analysis of the learning history, and a procedure of knowledge augmentation. The continuous learning may be defined as a repeatable learning process of automating optimization of an abbreviation criterion for abbreviating data through continuous knowledge augmentation.

The data meta-scaling apparatus according to the first embodiment of the present invention may extract schema information from input data or a user input and may set abbreviation criterion information, learning criterion information, and knowledge augmentation criterion information, based on the extracted schema information, thereby completing preparation for performing the continuous learning.

Subsequently, the data meta-scaling apparatus according to the first embodiment of the present invention may perform abbreviation of data, based on the abbreviation criterion or an abbreviation rule prescribed in the abbreviation criterion information and may perform learning on a model capable of appropriately expressing the abbreviated data, based on a learning criterion prescribed in the learning criterion information. Learning may be repeatedly performed based on a knowledge augmentation criterion, and a result of the learning may be automatically stored as a learning history.

If the learning history is sufficiently stored to satisfy the knowledge augmentation criterion prescribed in the knowledge augmentation criterion information, the data meta-scaling apparatus according to the first embodiment of the present invention may analyze the learning history to perform optimization of the abbreviation criterion.

Through such a process, a procedure of constructing the continuous learning may be automated, and optimization of the abbreviation criterion for abbreviating data may be automated through continuous knowledge augmentation.

Referring to FIG. 1, the data meta-scaling apparatus according to the first embodiment of the present invention may include a meta-optimizer 10, an abbreviator 20, a learning machine 30, an evaluator 40, and an analyzer 50.

The meta-optimizer 10 may perform a process of setting abbreviation criterion information, learning criterion information, and knowledge augmentation criterion information with reference to schema information of input data. The schema information may be obtained by analyzing metadata of the input data. The metadata may be included in a specific region of the input data. The metadata may be data for explaining an attribute of the input data.

The schema information may be provided by a user input. The input data may include pieces of attribute information and may be provided in a continuous stream form or an archive form. For example, the input data may be data collected from various thing devices such as a sensing device in an Internet of things (IoT) service environment.

The abbreviator 20 may perform a process of abbreviating the input data by using the abbreviation criterion information set by the meta-optimizer 10. The input data may be directly input from the various thing devices or may be input from a data storage unit. An input of data may include a physical input of real data and an input of logical location information about a logical location at which the data is located. Here, the logical location information may be, for example, uniform resource locator (URL) information.

The learning machine 30 may perform ML on abbreviation data abbreviated by the abbreviator 20 by using the learning criterion information set by the meta-optimizer 10. A kind of the ML or a characteristic of a hyperparameter necessary for performing the ML is limited without departing from the gist of the present invention. That is, the present invention may be applied to all kinds of MLs regardless of the characteristic of the hyperparameter necessary for performing the ML, and this can be sufficiently understood by those skilled in the art through description below. The learning machine 30 may perform the ML by using all of the abbreviation data and the input data. This denotes that a new attribute extracted through data abbreviation may be added to the input data to extend the input data, and learning may be performed on the extended input data.

The evaluator 40 may determine whether the learning process or the learning result satisfies a learning criterion, based on the learning criterion information set by the meta-optimizer 10 and may perform a process of evaluating a suitability of data abbreviation, based on a result of the determination.

The analyzer 50 may analyze metadata included in the input data or metadata provided along with the input data to extract schema information of the input data.

The meta-optimizer 10 may perform knowledge augmentation or changing of the abbreviation criterion information, based on evaluation result information of the evaluator 40.

When it is determined that the learning process or the learning result does not satisfy the learning criterion prescribed in the learning criterion information, the meta-optimizer 10 may perform a process of changing the abbreviation criterion information, based on a knowledge augmentation criterion. On the other hand, when it is determined that the learning process or the learning result satisfies the learning criterion, the meta-optimizer 10 may start a knowledge augmentation process through a process of automatically storing the learning result as a learning history in a storage unit.

When the learning history is sufficiently stored to satisfy the knowledge augmentation criterion prescribed in the knowledge augmentation criterion information, the meta-optimizer 10 may analyze the stored learning history to perform a process of performing optimization of the abbreviation criterion. Through such a process, a procedure of constructing the continuous learning may be automated, and optimization of the abbreviation criterion for abbreviating data may be automated through continuous knowledge augmentation.

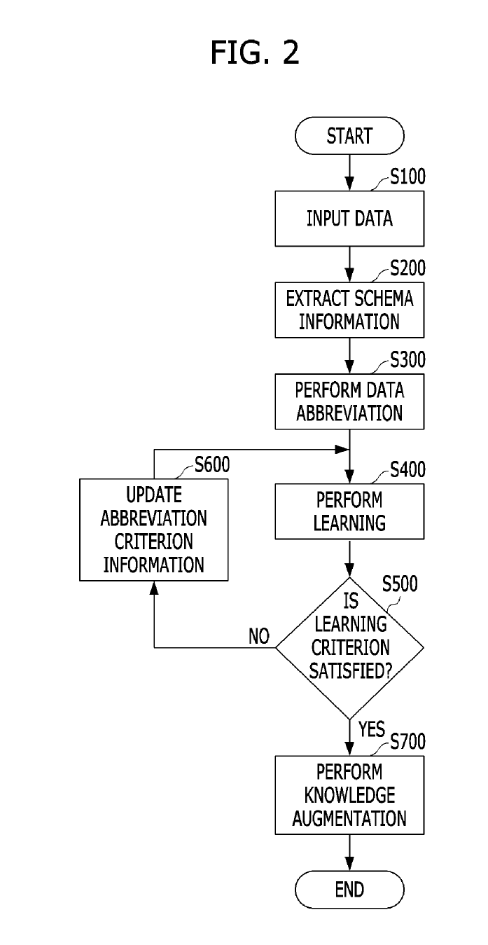

FIG. 2 is a flowchart illustrating a data meta-scaling method for continuous learning according to a first embodiment of the present invention.

Referring to FIG. 2, first, in step S100, a process of inputting input data from a thing device or a data storage unit to the meta-optimizer 10 may be performed.

Subsequently, in step S200, a process of analyzing (parsing), by the meta-optimizer 10, metadata included in the input data to extract schema information of the input data and setting abbreviation criterion information, learning criterion information, and knowledge augmentation criterion information, based on the extracted schema information.

Subsequently, in step S300, a process of abbreviating, by the abbreviator 20, the input data by using the abbreviation criterion information may be performed. The abbreviated data may be directly provided to the learning machine 30 in a real-time stream or batch manner. On the other hand, instead of providing the abbreviated data, the abbreviated data may be stored in a storage medium, and the abbreviator 20 may notify the learning machine 30 of a storage address. In this case, the learning machine 30 may access the storage medium at the storage address to read the abbreviation criterion information.

Subsequently, in step S400, a process of performing, by the learning machine 30, learning on a model capable of appropriately expressing the abbreviated data to generate a learning model may be performed. At this time, the learning machine 30 may perform learning, based on the learning criterion information.

Subsequently, in step S500, a process of determining, by the evaluator 40, whether a result of the learning satisfies a learning criterion prescribed in the learning criterion information may be performed.

When the learning result does not satisfy the learning criterion, a process of updating, by the meta-optimizer 10, the abbreviation criterion information based on a knowledge augmentation criterion prescribed in the knowledge augmentation criterion information may be performed in step S600.

On the other hand, when the learning result satisfies the learning criterion, a learning history may be sufficiently stored so as to satisfy the knowledge augmentation criterion, a process of analyzing, by the meta-optimizer 10, the sufficiently stored learning history to perform optimization of an abbreviation criterion may be performed. Through such a knowledge augmentation process, optimization of the abbreviation criterion for abbreviating data through continuous knowledge augmentation may be automated.

In an embodiment of the present invention, input data may have various attributes. In order to express the various attributes, in an embodiment of the present invention, the term “data dimension” may be defined. A data dimension may be defined as an attribute for expressing data.

Example of Data Dimension

Data collected at a specific time interval or an unspecific time interval may be expressed as a time attribute. Therefore, a dimension of data expressible as the time attribute may be “time”.

Data such as latitude and longitude coordinates, address information, a postcode, and a subnet of Internet protocol (IP) may be expressed as a space attribute representing a physical or logical location. Therefore, a dimension of data expressible as the space attribute may be “space”.

Data representing a color may be expressed as attributes such as hue, saturation, and intensity. Therefore, a dimension of data expressing a color may be hue, saturation, or intensity.

Data representing a material may be expressed as a unique attribute of the material such as hardness, density, specific gravity, and conductivity. Therefore, a dimension of data expressing a material may be hardness, density, specific gravity, or conductivity.

In data which varies based on a frequency, the frequency may be defined as a data dimension.

In data which is defined based on a socially assigned meaning category such as residence, workplace, one floor, etc., the meaning category may be defined as a data dimension.

A dimension of data representing a result of evaluation of an arbitrary service by a user group may be preference or effectiveness.

In a moving image captured by a mobile camera, a photographing location, a photographing time, and the like may be defined as data dimensions. In this case, the photographing position may be expressed as XYZ coordinates in a three-dimensional (3D) space, and thus, may be subdivided into three data dimensions.

As described above, all data may be expressed as various dimensions by an attribute thereof, and thus, in an embodiment of the present invention, a criterion for determining a dimension of data is not limited.

Abbreviation of Data

In a case where arbitrary data is expressed as an arbitrary data dimension, data abbreviation according to an embodiment of the present invention may be defined as a process of sampling the arbitrary data in the arbitrary data dimension.

Moreover, the data abbreviation according to an embodiment of the present invention may be defined as a process of changing a data dimension of arbitrary data to another data dimension. The changing of the dimension denotes a reduction in range where data is expressed. Depending on the case, the changing of the dimension may denote an increase in range where data is expressed.

In this manner, the data abbreviation according to an embodiment of the present invention may be one of sampling in various dimensions, dimension transform, and a process of combining the sampling and the dimension transform, or may be defined as a process of reducing the number of pieces of data through the process.

Sampling Based on Abbreviation of Data

Sampling may be a process of selecting a representative value in one or more data dimensions according to a predetermined criterion.

The sampling may include single dimension-based sampling and multi-dimension-based sampling. The single dimension-based sampling may be a process of selecting a representative value in a single data dimension. The multi-dimension-based sampling may be a process of selecting each of representative values in two or more data dimensions.

A. Single Dimension-Based Sampling

A single dimension-based sampling process may include a periodic sampling process, an aperiodic sampling process, a fixed window-based sampling process, and a moving window-based sampling process.

The periodic sampling process may be a process of periodically selecting a representative value in an assigned window in a data dimension, and for example, the periodic sampling process may be a process of selecting a representative value based on a specific criterion in an assigned window at intervals of five minutes with respect to data expressed in a time dimension. Here, the window may be construed as a unit of sampling.

The aperiodic sampling process may be a process of aperiodically selecting a representative value in an assigned window, and for example, the aperiodic sampling process may be a process of selecting a representative value based on a specific criterion in an assigned window with respect to a case where a value of data is equal to or greater than a predetermined value, or may be a process of selecting a representative value by applying a time window or a space window with respect to some data, where a temperature is 15 degrees or more, of pieces of data measured by a temperature sensor in an arbitrary space.

The fixed window-based sampling process may be a process of selecting representative values in two or more windows which are continuous without overlapping each other in a data dimension, and for example, the fixed window-based sampling process may be a process of selecting a representative value based on a specific criterion from among pieces of input data collected in a first time period “t₁-t₃” in a time dimension and selecting a representative value based on the same specific criterion from among pieces of input data collected in a second time period “t₃-t₅” succeeding the first time period.

The moving window-based sampling process may be a process of selecting representative values in two or more windows overlapping each other in a data dimension, and for example, the moving window-based sampling process may be a process of selecting a representative value based on a specific criterion from among pieces of input data collected in a first time period “t₁-t₃” in a time dimension and selecting a representative value based on the same specific criterion from among pieces of input data collected in a second time period “t₂-t₄” overlapping a partial period of the first time period.

B. Multi-Dimension-Based Sampling

A multi-dimension-based sampling process may be a process of independently performing single dimension sampling in each dimension on data expressed as two or more data dimensions. For example, data collected by a sensor located in an arbitrary zone may include an attribute including at least one of a temperature, humidity, illuminance, and noise, and the sensor may be located at various locations. Data measured by the sensor may be periodically collected or may be aperiodically collected based on a value of the data collected by the sensor. In such a data collection environment, the temperature may be used to perform the fixed window-based sampling defined as five minutes regardless of locations for each of all sensors, the humidity may be used to perform the fixed window-based sampling defined as an interval of 7 m with respect to a specific location, the illuminance may be used to perform the moving window-based sampling at the same location as the humidity, and the noise may be used to perform the aperiodic sampling for selecting only data having a certain reference value or more from among pieces of noise data.

A criterion for selecting a representative value in the assigned window may include a rule predefined by a user and a statistical feature of data included in the window. For example, the user may define the rule so as to select a value of a location closest to a specific criterion, a value of a location farthest away from the specific criterion, and a value of a center location in the specific criterion from among data included in the assigned window.

Moreover, the representative value may be one of values, such as an average value, a medium value, a maximum value, a minimum value, a quartile value, a standard deviation value, and a most frequent value defined as various statistical features, or a combination thereof. That is, the average value and the standard deviation value may be selected as representative values from among all pieces of data included in the assigned window.

Dimension Transform Based on Abbreviation of Data

Dimension transform may be a process of changing a structure of a data dimension, where data is expressed, to express data in a new dimension, and for example, the dimension transform may include frequency domain transform, multivariate analysis, nonlinear dimensionality reduction, etc.

The frequency domain transform such as Fourier transform may be a process of decomposing data, expressed in a time dimension or a space dimension, into a frequency component to express the data in a frequency dimension, and the data decomposed into the frequency component may be limited to include only up to a cutting frequency, thereby achieving data abbreviation.

The multivariate analysis may be a process of statistically calculating data expressed in a multi-dimension space to obtain a new dimension which enables the same data to be expressed, and the number of dimensions may be limited to an appropriate statistical criterion in a space defined as the new dimension, thereby achieving data abbreviation. Examples of the multivariate analysis may include principal component analysis, clustering, etc.

The nonlinear dimensionality reduction may nonlinearly reduce the number of dimensions by using various manifold learnings such as nonlinear principal component analysis, diffeomorphic dimensionality reduction, curvilinear distance analysis, and manifold learning, thereby achieving data abbreviation.

Combination of Data Abbreviation-Based Sampling and Dimension Transform

A combination of sampling and dimension transform may be a process of sequentially performing the sampling and the dimension transform, and for example, may be a process of sampling input data, transforming a dimension of the sampled data or transforming a dimension of the input data, and sampling the input data in the transformed dimension to decrease the number of pieces of data.

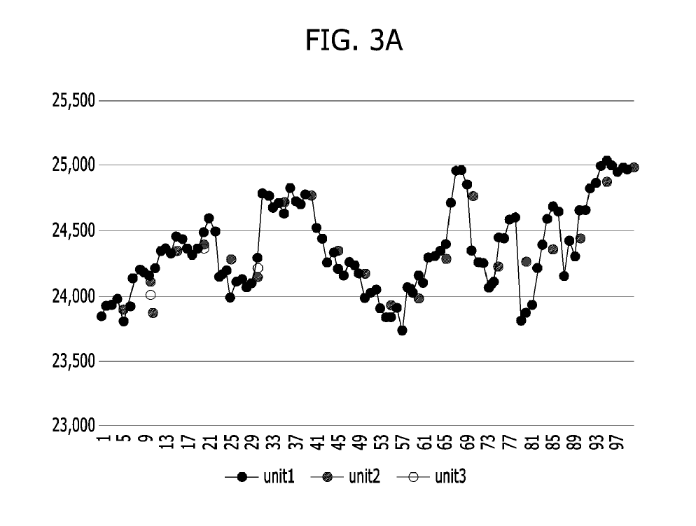

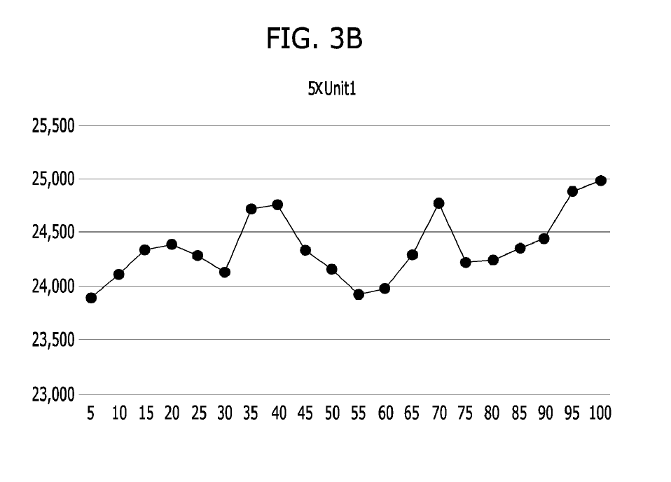

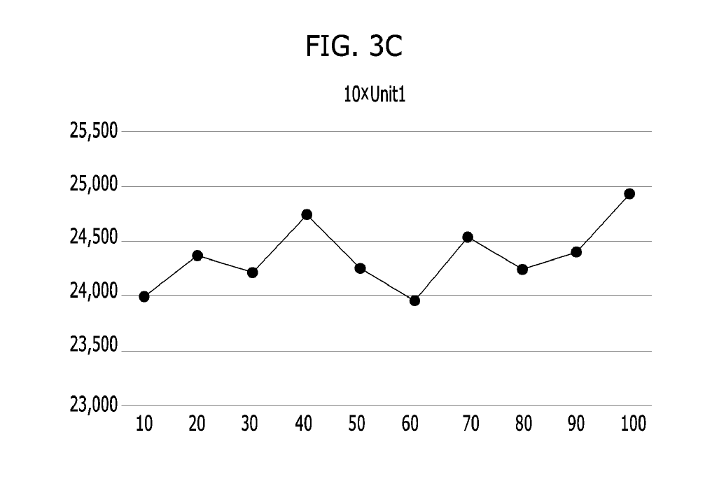

FIGS. 3A to 3C are diagrams for describing single dimension-based sampling in data abbreviation according to an embodiment of the present invention.

FIGS. 3A to 3C illustrate an example of time dimension-based sampling for selecting an average as a representative value by using a fixed window in a time dimension, FIG. 3A illustrates graph-type original data, and FIGS. 3B and 3C illustrate graph-type abbreviation data obtained by sampling original data by using fixed windows having different sizes according to time dimension-based sampling.

In FIG. 3A, when a time interval at which original data is collected in a time dimension is unit1, abbreviation data illustrated in FIG. 3B is obtained by sampling original data by using a fixed window which is set as a time interval “unit2” of 5×unit1, and FIG. 3C is obtained by sampling original data by using a fixed window which is set as a time interval “unit3” of 10×unit1.

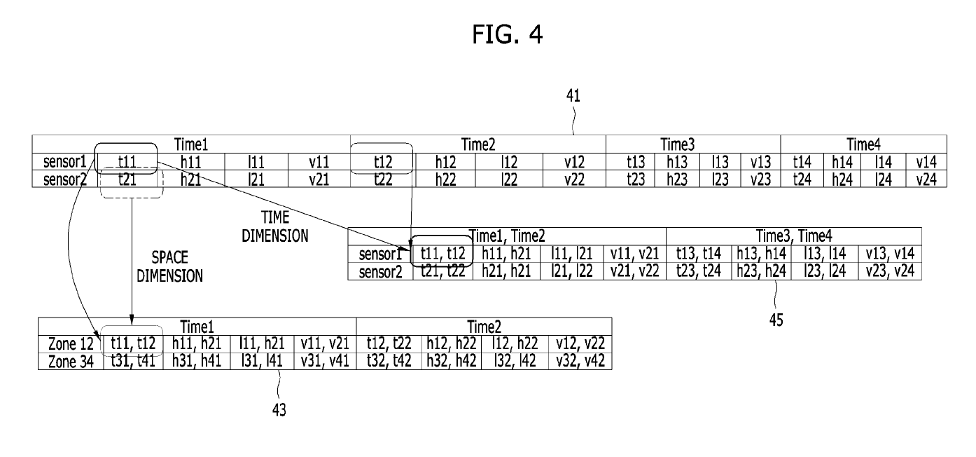

FIG. 4 is a diagram for describing multi-dimension-based sampling in data abbreviation according to an embodiment of the present invention.

FIG. 4 illustrates sampling of original data capable of being expressed in a multi-dimension including a space dimension and a time dimension, reference numeral 41 refers to original data collected at a certain time interval from two sensors “sensor1 and sensor2” installed at different places and refers to table-type sensor data, reference numeral 43 refers to abbreviation data obtained by abbreviating original data 41 in the space dimension, and reference numeral 45 refers to abbreviation data obtained by abbreviating the original data 41 in the time dimension.

t11, t12, t13, and t14 refer to pieces of temperature data collected by a first sensor “sensor1” at a time Time1, a time Time2, a time Time3, and a time Time4, respectively, and t21, t22, t23, t24 refer to pieces of temperature data collected by a second sensor “sensor2” at the time Time1, the time Time2, the time Time3, and the time Time4, respectively.

h11, h12, h13, and h14 refer to pieces of humidity data collected by the first sensor “sensor1” at the time Time1, the time Time2, the time Time3, and the time Time4, respectively, and h21, h22, h23, and h24 refer to pieces of humidity data collected by the second sensor “sensor2” at the time Time1, the time Time2, the time Time3, and the time Time4, respectively.

111, 112, 113, and 114 refer to pieces of illuminance data collected by the first sensor “sensor1” at the time Time1, the time Time2, the time Time3, and the time Time4, respectively, and 121, 122, 123, and 124 refer to pieces of illuminance data collected by the second sensor “sensor2” at the time Time1, the time Time2, the time Time3, and the time Time4, respectively.

v11, v12, v13, and v14 refer to pieces of voltage data collected by the first sensor “sensor1” at the time Time1, the time Time2, the time Time3, and the time Time4, respectively, and v21, v22, v23, and v24 refer to pieces of voltage data collected by the second sensor “sensor2” at the time Time1, the time Time2, the time Time3, and the time Time4, respectively.

As described above, since the original data are pieces of data collected at a certain time interval by the two sensors “sensor1 and sensor2” installed at different places, the original data may be expressed as the multi-dimension including the space dimension and the time dimension.

If a multi-dimension-based sampling process is applied to the sensor data, original data expressed in the multi-dimension may be abbreviated to abbreviation data expressed in the space dimension and/or abbreviation data expressed in the time dimension. For example, a process of selecting one of t11 and t21 as a representative value or a process of selecting one of h11 and h21 as a representative value may be a process of abbreviating the original data, expressed in the multi-dimension, to data expressed in the space dimension. The process of selecting one of t11 and t21 as a representative value or a process of selecting one of h11 and h21 as a representative value may be a process of abbreviating the original data, expressed in the multi-dimension, to data expressed in the time dimension.

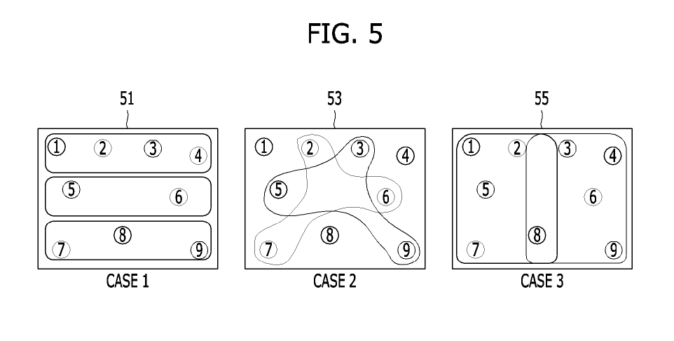

FIG. 5 is a diagram for describing multi-dimension-based sampling in data abbreviation according to another embodiment of the present invention and schematically illustrates multi-dimension-based data abbreviation based on locations and meanings of sensors installed in a certain space.

In FIG. 5, reference numerals 51, 53, and 55 referring to tetragonal boxes refer to certain spaces where sensors are installed, and numbers illustrated in a circle in the spaces 51, 53, and 55 are numbers for identifying the sensors.

In FIG. 5, an example where the sensors installed in the respective spaces are grouped into three cases is illustrated.

CASE1 represents an example where sensors installed in the same space in the space 51 are grouped into a plurality of groups, and data is abbreviated by selecting one representative value from among values measured by sensors included in each of the groups.

CASE2 represents an example where the same kinds of sensors in the space 53 are grouped into a plurality of groups, and data is abbreviated by selecting one representative value from among values measured by sensors included in each of the groups.

CASE3 represents an example where sensors are grouped into a plurality of groups with respect to a special meaning, and data is abbreviated by selecting one representative value from among values measured by sensors included in each of the groups. In CASE3, a criterion for grouping the sensors may include a left region and a right region with respect to a center.

Hereinafter, the abbreviation criterion information, the learning criterion information, and the knowledge augmentation criterion information set by the meta-optimizer will be described in detail.

As described above, the meta-optimizer 10 may set the abbreviation criterion information, the learning criterion information, and the knowledge augmentation criterion information with reference to schema information of input data.

The schema information may be obtained by analyzing metadata provided along with the input data or metadata stored in a specific region of the input data, or may be obtained from a user input.

The schema information may include the abbreviation criterion information, the learning criterion information, and the knowledge augmentation criterion information. Content of the schema information may be described according to a predetermined rule or may be described in the form of a knowledge dictionary expressed as structured knowledge such as ontology.

Abbreviation Criterion Information

The abbreviation criterion information may include information about a data dimension and information about data abbreviation. The information about the data abbreviation may include at least one of criterion information for periodic sampling, criterion information for aperiodic sampling, criterion information for fixed window sampling, and criterion information for moving window sampling, and additionally, may further include common criterion information applied regardless of a sampling criterion.

The criterion information associated with the periodic sampling may include inter-window interval information for setting a location of a window in a data dimension and size information about a window for selecting a representative value.

The criterion information associated with the aperiodic sampling may include condition information for aperiodically selecting a window and size information about a window for selecting a representative value.

The criterion information associated with the fixed window sampling may include size information about a window which is assigned in order for a plurality of windows to overlap each other in the data dimension.

The criterion information associated with the moving window sampling may include interval information for setting locations of windows overlapping each other in the data dimension and size information about a window for selecting a representative value.

The common criterion information applied regardless of the sampling criterion may include criterion information for selecting a representative value in a size of a window.

Learning Criterion Information

In an embodiment of the present invention, performance of a learning model or reliability (or accuracy) of a learning result may be used as indicators for evaluating suitability of data abbreviation.

The learning criterion information may include an early stop condition for limiting repetition of learning and a convergence trend condition, and additionally, may further include a learning reliability condition for calculating performance of learning.

The learning reliability condition may be used as a condition for limiting repetition of learning as well as evaluation of learning performance.

A selection of a learning criterion capable of being changed based on a characteristic of a learning model may be determined based on schema information, and thus, the learning criterion may be variously configured. Therefore, in an embodiment of the present invention, the learning criterion is not limited.

Data (i.e., learning data) which is to be learned may include, for example, a train dataset, a validation dataset, and a test dataset.

The train dataset may be used to train the learning model. The validation dataset may be used to abbreviate appropriate data. The test dataset may be used to determine effectiveness or suitability of selected data abbreviation. The train dataset and the validation dataset may be the same dataset.

The early stop condition and the convergence trend condition may correspond to a type of regularization which is used for preventing a memorization effect in a learning process of optimizing the learning model through learning repetition, and a learning result may limit a range of repetitive learning which is performed before satisfying the predetermined learning reliability condition.

The learning reliability condition may use indicators such as precision, accuracy, and an area under curve (AUC) mainly used in a classification model, indicators such as a root mean squared error (RMSE), a mean absolute error (MAE), a relative absolute error (RAE), a relative square error (RSE), and a coefficient of determination mainly used in a regression model, and indicators such as compactness of a cluster, a maximal distance to cluster center, and a distance between clusters mainly used in a clustering model.

In the suitability of the data abbreviation, whether a learning process or a learning result satisfies a criterion prescribed in the learning criterion may be evaluated. The early stop condition or the convergence trend condition may be used for limiting learning repetition, and thus, when a case where the learning process or the learning result satisfies the early stop condition or the convergence trend condition occurs in a state where the learning result or the learning process does not satisfy the predetermined learning reliability condition, the learning process may automatically end.

When learning ends, the data abbreviation may be determined as being unsuitable, and repetitive learning may be performed based on changing of the abbreviation criterion information so as to enable suitable data abbreviation.

If repetition of learning does not satisfy the early stop condition or the convergence trend condition but satisfies the learning reliability condition, the learning process may automatically end. In this state, when the learning process ends, the data abbreviation may be determined as being suitable. The learning result may be stored as a learning history.

The stored learning history may include pieces of information (for example, input data, schema information, abbreviation criterion information, abbreviation data information, learning criterion information, learning data information, learning model information, learning result information, and knowledge augmentation criterion information) which are generated in a continuous learning process.

When the data abbreviation is determined as being suitable and satisfies a knowledge augmentation criterion, a knowledge augmentation process of optimizing the abbreviation criterion information may be performed.

Knowledge Augmentation Criterion Information

In an embodiment of the present invention, the knowledge augmentation criterion information may define a criterion and a condition for updating the abbreviation criterion information.

The knowledge augmentation criterion information may include a limitation of a learning criterion (or a repetitive learning criterion), changing of an abbreviation criterion, and a history accumulation criterion. The knowledge augmentation criterion information may not include change information about the abbreviation criterion and repetitive learning criterion information, and depending on the case, the knowledge augmentation criterion information may include only the history accumulation information.

The repetitive learning criterion information may represent a factor of the learning criterion which should be satisfied in a knowledge augmentation process of optimizing a data abbreviation criterion.

The change information about the abbreviation criterion may represent a factor and a range which enable the abbreviation criterion to be changed.

The history accumulation criterion may represent a condition which should be satisfied before performing knowledge augmentation for optimizing the abbreviation criterion information, and may include a learning history accumulation condition and an abbreviation criterion change condition. If the conditions are not satisfied, the knowledge augmentation for optimizing the abbreviation criterion information may not be performed.

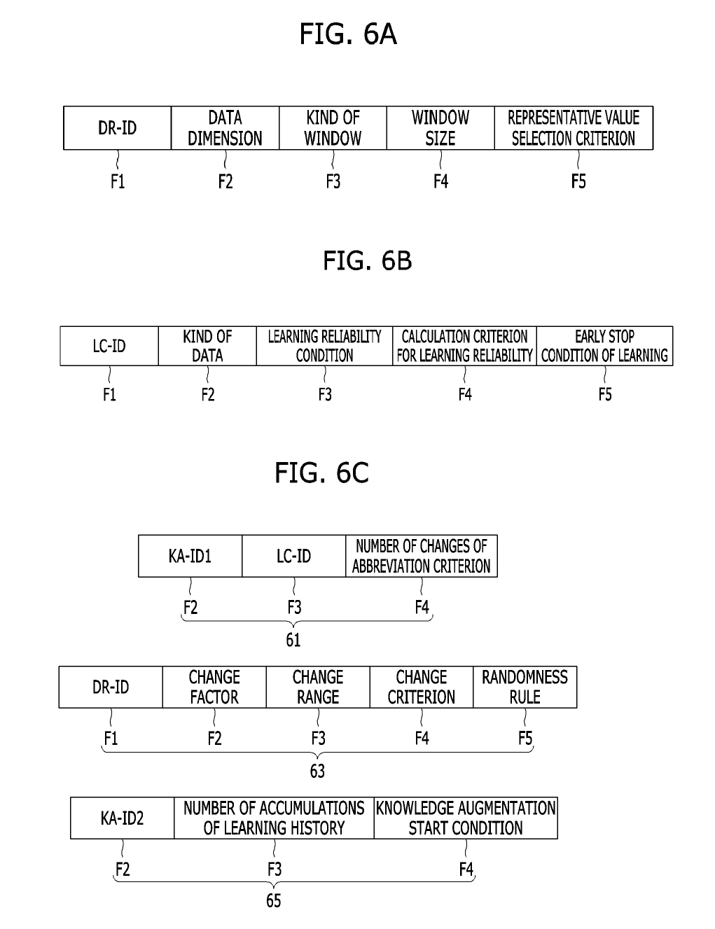

FIG. 6A is a diagram illustrating a data structure of abbreviation criterion information included in schema information according to an embodiment of the present invention.

Referring to FIG. 6A, the data structure of the abbreviation criterion information may include, for example, five fields F1 to F5. An identifier (ID) of abbreviation criterion information such as DR-ID may be recorded in a first field F1. Information representing a data dimension may be recorded in a second field F2. Information representing a kind of a window used for data abbreviation may be recorded in a third field F3. Information representing a size of a window may be recorded in a fourth field F4. Information representing a criterion for selecting a representative value may be recorded in a fifth field F5. A representative value selection criterion may be information associated with an attribute of a representative value, a kind of the representative value, a representative value selecting method, or a representative value calculating method. The order of fields may be various changed depending on a design.

If “DR001” is recorded in the first field F1, “time” is recorded in the second field F2, “fixed window” is recorded in the third field F3, “ten minutes” are recorded in the fourth field F4, and “average” is recorded in the fifth field F5, the abbreviation criterion information may be identified as DR001 and may define an abbreviation rule which selects, as a representative value, an average value selected by using a fixed window having a window size “ten minutes” in a time dimension.

FIG. 6B is a diagram illustrating a data structure of learning criterion information included in schema information according to an embodiment of the present invention.

Referring to FIG. 6B, the data structure of the learning criterion information may include, for example, five fields F1 to F5. An ID (a learning condition-identifier (LC-ID) of the learning criterion information may be recorded in a first field F1. Information associated with a kind of data used for calculating learning reliability may be recorded in a second field F2. Information associated with a learning reliability condition may be recorded in a third field F3. Information associated with a criterion for calculating learning reliability may be recorded in a fourth field F4. Here, the criterion for calculating learning reliability may be information associated with a method of calculating learning reliability. Information associated with an early stop condition for learning may be recorded in a fifth field F5.

If “LC001” is recorded in the first field, “validation data” is recorded in the second field, “5% or less” is recorded in the third field, “root mean square error (RMSE)” is recorded in the fourth field, and “2,000 times or more” is recorded in the fifth field, the learning criterion information may be identified as “LC001” and may define a rule where learning reliability is calculated by using the validation data, and in a learning process, when an RMSE of learning reliability is 5% or less or the number of learning repetitions is 2,000 or more, learning stops.

On the other hand, in the above example, the learning criterion information may define a rule where in the learning process, when the number of learning repetitions is less than 2,000 and an RMSE value of learning reliability calculated from the validation data reaches a value less than 5%, the learning reliability satisfies the learning criterion.

On the other hand, in the above example, the learning criterion information may define a rule where when an RMSE value is 5% or more in the moment the number of learning repetitions exceeds 2,000, the learning reliability satisfied the learning criterion.

FIG. 6C is a diagram illustrating a data structure of knowledge augmentation criterion information included in schema information according to an embodiment of the present invention.

Referring to FIG. 6C, the knowledge augmentation criterion information may include repetitive learning criterion information 61, abbreviation criterion change information 63, and history accumulation criterion information 65.

Repetitive Learning Criterion Information 61

The repetitive learning criterion information 61 may include three fields F1 to F3. An ID (a knowledge augmentation identifier (KA-ID)) of repetitive learning criterion information may be recorded in a first field F1, an ID (an LC-ID) of learning criterion information to propose may be recorded in a second field F2, and the number of changes of an abbreviation criterion may be recorded in a third field F3.

The repetitive learning criterion information 61 may define a rule where in a case where the number of learning repetitions based on abbreviation criterion change is five or less, if a condition (for example, a condition where the number of learning repetitions is 2,000 or less and an RMSE is less than 5%) limited in the learning criterion information identified as an LC-ID is not satisfied, repetitive learning may be performed by changing the abbreviation criterion, but the number of changes of the abbreviation criterion is allowed only up to five. That is, the rule defined in the repetitive learning criterion information 61 may define a case where if a learning result satisfies the condition limited in the learning criterion information in a process of changing the abbreviation criterion five times, the learning result is stored as a learning history, and the changing of the abbreviation criterion ends, but if the learning result does not satisfy the condition limited in the learning criterion information until the abbreviation criterion is changed five times, the learning result is not stored as the learning history. Here, the stored learning history may include pieces of information (for example, input data, schema information, abbreviation criterion information, abbreviation data information, learning criterion information, learning data information, learning model information, learning result information, and knowledge augmentation criterion information) which are generated in a continuous learning process.

Abbreviation Criterion Change Information 63

A data structure of the abbreviation criterion change information 63 may include five fields F1 to F5. An ID (a DR-ID) of abbreviation criterion information corresponding to a change target may be recorded in a first field F1, information associated with a change factor changed in the abbreviation criterion information identified by the DR-ID may be recorded in a second field F2, information associated with a change range of the change factor recorded in the second field F2 may be recorded in a third field F3, information associated with a change criterion specified in the change range may be recorded in a fourth field F4, and information associated with a rule which arbitrarily changes the change criterion may be recorded in a fifth field F5.

For example, in a case where the change factor is a size of a fixed window, the change range includes 0.5 time, 1.0 times, and 1.5 times, the change criterion is ten minutes, and a randomness rule is 30.0% of ten minutes, the abbreviation criterion change information 63 may define changing of the abbreviation criterion where the size “ten minutes” of the fixed window is extended or reduced to sizes “five minutes”, “ten minutes”, and “fifteen minutes” of the fixed window, and the size of the fixed window is arbitrarily changed within a 30% range of ten minutes.

In order to arbitrarily change the size of the fixed window, a random function may be used for setting various windows, or a gene algorithm for causing randomness through a hybridization and mutation process may be used.

Therefore, a size of a window may be variously and automatically set to [three minutes, ten minutes, seventeen minutes], [seven minutes, thirteen minutes, fifteen minutes], [five minutes, nine minutes, sixteen minutes], etc.

History Accumulation Criterion Information 65

When a process based on a rule of a repetitive learning criterion is completed, a process based on a rule of a history accumulation criterion may start subsequently.

The history accumulation criterion information 65 may be a rule which defines a learning history accumulation criterion, and may define abbreviation criterion change for learning accumulation and knowledge augmentation start.

A data structure of the history accumulation criterion information 65 may include three fields F1 to F3. An ID (a KA-ID2) of the history accumulation criterion information may be recorded in a first field F1, information associated with the number of accumulations of a learning history may be recorded in a second field F2, and the number of changes of an abbreviation criterion for performing knowledge augmentation may be recorded in a third field F3.

If the number of accumulations for storing a learning result as the learning history is fifteen or more and the number of changes of the abbreviation criterion for performing knowledge augmentation is six or more, the knowledge augmentation for optimizing abbreviation criterion information may be performed whenever the learning history is stored. However, if at least one of learning history accumulation or abbreviation criterion change is not satisfied, the knowledge augmentation may not be performed.

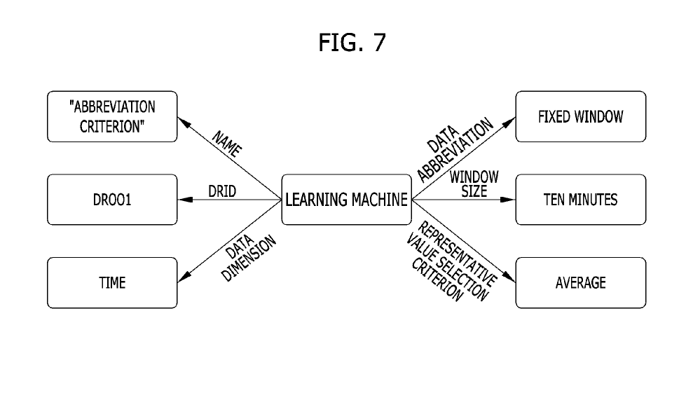

FIG. 7 is a diagram illustrating an example where schema information according to another embodiment of the present invention is expressed as ontology.

The ontology illustrated in FIG. 7 may be ontology expressing abbreviation criterion information. A rule or structured knowledge described in an embodiment of the present invention may be set in various manners and is not limited to an example described in an embodiment of the present invention.

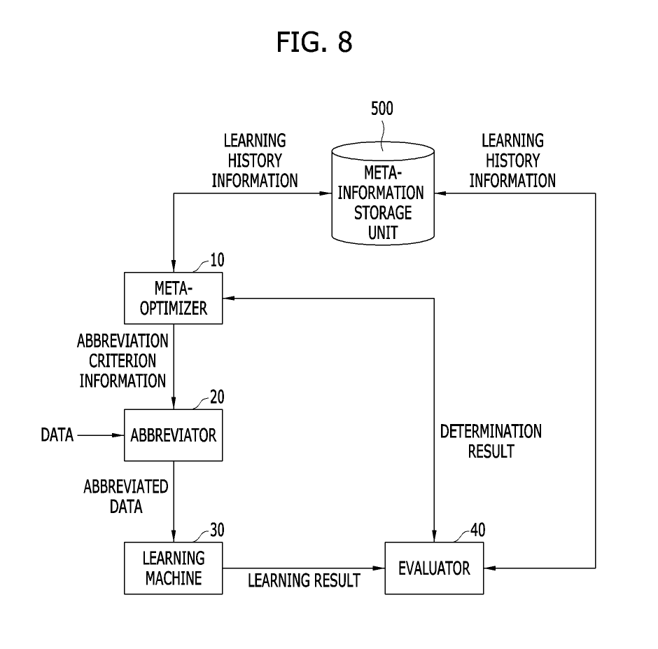

FIG. 8 is a block diagram illustrating a data meta-scaling apparatus for continuous learning according to a second embodiment of the present invention.

Referring to FIG. 8, the data meta-scaling apparatus according to the second embodiment of the present invention may include a meta-optimizer 10, an abbreviator 20, a learning machine 30, an evaluator 40, and a meta-information storage unit 50.

The meta-information storage unit 50 may store learning history information. The learning history information may include pieces of information (i.e., all pieces of information input/output to/from the meta-optimizer 10, the abbreviator 20, the learning machine 30, and the evaluator 40) which are generated in a continuous learning process, and for example, the learning history information may include input data information, schema information, learning model information, abbreviation criterion information, abbreviation data information, learning criterion information, learning data information, learning model information, learning result information, and knowledge augmentation criterion information.

The meta-optimizer 10, the abbreviator 20, the learning machine 30, and the evaluator 40 may use the meta-information storage unit 50 in a process of inputting/outputting the learning history information for interoperation. For example, the meta-optimizer 10 may store abbreviation criterion information, learning criterion information, and knowledge augmentation criterion information, which are extracted from the schema information or provided according to a user input, in the meta-information storage unit 50, and subsequently, when the meta-optimizer 10 transfers a storage location of the meta-information storage unit 50 to the abbreviator 20, the abbreviator 20 may read the abbreviation criterion information from the meta-information storage unit 50 to abbreviate a dimension of input data, based on the abbreviation criterion information.

Moreover, when the abbreviator 20 stores abbreviation data in the meta-information storage unit 50, the learning machine 30 may read the stored abbreviation data from the meta-information storage unit 50 and may generate learning data from the read abbreviation data, thereby performing ML.

Likewise, when the learning machine 30 stores learning result information in the meta-information storage unit 50, the evaluator 40 may read the learning result information from the meta-information storage unit 50 to determine whether a learning result satisfies a learning criterion.

Finally, the meta-optimizer 10 may perform knowledge augmentation or an update of the abbreviation criterion information, based on a result of the determination by the evaluator 40.

According to the above-described second embodiment, the data meta-scaling apparatus may accumulate the learning history information and may store the accumulated learning history information, and when the learning history information is sufficiently stored so as to satisfy the knowledge augmentation criterion, the data meta-scaling apparatus may analyze the learning history to obtain an optimal abbreviation criterion, thereby automatically updating the schema information. Through such a process, a procedure of constructing the continuous learning may be automated, and optimization of the abbreviation criterion for abbreviating data may be automated through continuous knowledge augmentation.

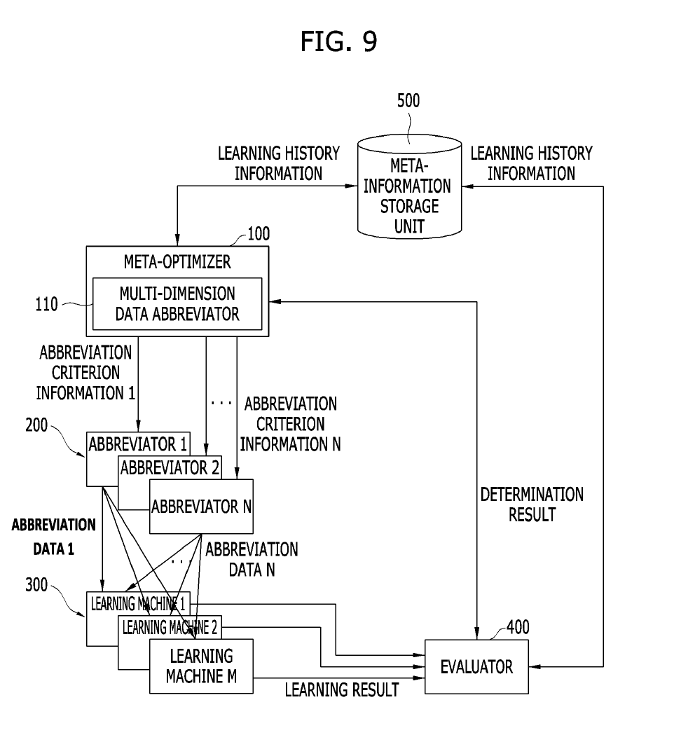

FIG. 9 is a block diagram illustrating a data meta-scaling apparatus for continuous learning according to a third embodiment of the present invention.

Referring to FIG. 9, the data meta-scaling apparatus according to the third embodiment of the present invention may include a meta-optimizer 100, a plurality of abbreviators 200 (1, 2, . . . , and N), and a plurality of learning machines 300 (1, 2, . . . , and M), an evaluator 400, and a meta-information storage unit 500.

The data meta-scaling apparatus according to the third embodiment of the present invention may include the plurality of abbreviators and the plurality of learning machines unlike the embodiments of FIGS. 1 and 8 where one abbreviator and one learning machine are provided, and thus, the plurality of learning machines may perform learning of pieces of data, abbreviated by the plurality of abbreviators 200, in parallel.

In this case, the meta-optimizer 100 may include a multi-dimension data abbreviator 110, for setting the pieces of abbreviation criterion information respectively provided from the plurality of abbreviators 200.

The multi-dimension data abbreviator 110 may set an abbreviation criterion information set including pieces of abbreviation criterion information generated based on a combination of various units of abbreviation defined in various dimensions which enable an attribute of data to be expressed.

In detail, the multi-dimension data abbreviator 110 may combine units of abbreviation of various dimensions enabling expression of data by using a gene algorithm to set the abbreviation criterion information set (abbreviation criterion information 1 to abbreviation criterion information N).

The abbreviation criterion information 1 to the abbreviation criterion information N may be provided to the plurality of abbreviators 200, and each of the plurality of abbreviators 200 may abbreviate input data, based on abbreviation criterion information thereof. Here, since pieces of data input to the plurality of abbreviators 200 are the same but pieces of abbreviation criterion information applied thereto differ, pieces of abbreviation data output from the plurality of abbreviators 200 may differ.

Pieces of abbreviation data abbreviated based on pieces of different abbreviation criterion information may be respectively provided to the plurality of learning machines 300. The plurality of learning machines 300 may be configured with different learning machines and may learn pieces of abbreviation data abbreviated based on pieces of different abbreviation criterion information. That is, the plurality of learning machines 1 to M may perform parallel learning on abbreviation data abbreviated based on the abbreviation criterion information 1, and the parallel learning may be performed until the plurality of learning machines 1 to M complete parallel learning on abbreviation data M abbreviated based on the abbreviation criterion information N. Therefore, the plurality of learning machines 1 to M may provide N*M number of learning results to the evaluator 400.

The plurality of learning machines 1 to M may perform in parallel learning on pieces of abbreviation data abbreviated based on pieces of different abbreviation criterion information, based on one piece of common learning criterion information, but may perform in parallel learning on each of pieces of abbreviation data, based on pieces of different learning criterion information. In this case, the meta-optimizer 100 may set pieces of different learning criterion information.

The evaluator 400 may determine whether learning reliabilities of the N*M learning results satisfy a learning criterion. In this case, the reliabilities of the learning results may have different values due to various combinations of pieces of abbreviation data and learning models, and characteristics (for example, hyperparameters) of the learning models may differ.

The evaluator 400 may determine whether learning reliabilities of learning results provided from the plurality of learning machines 300 satisfy a learning criterion, and the meta-optimizer 100 may update all or some of pieces of abbreviation criterion information, based on the result of the determination by the evaluator 400.

When the learning reliabilities of the learning results do not satisfy the learning criterion, the meta-optimizer 100 may update the abbreviation criterion information, based on knowledge augmentation criterion information. When the learning reliabilities of the learning results satisfy the learning criterion, the meta-optimizer 100 may start a knowledge augmentation process through a process of automatically storing the learning results as a learning history.

The learning history may be sufficiently stored so as to satisfy a knowledge augmentation criterion, and then, the meta-optimizer 100 may analyze the learning history to perform a process of optimizing an abbreviation criterion. Through such a process, a procedure of constructing the continuous learning may be automated, and optimization of the abbreviation criterion for abbreviating data may be automated through continuous knowledge augmentation.

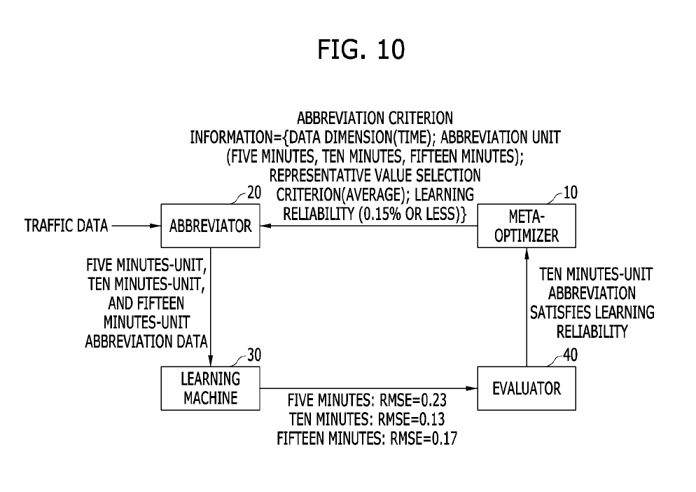

FIG. 10 is a diagram for describing an example where the data meta-scaling apparatus illustrated in FIG. 1 is applied to a traffic information prediction scenario.

Referring to FIG. 10, examples of abbreviation criterion information capable of being applied to the traffic information prediction scenario may include a data dimension defined as a time, a kind of a window defined as a fixed window, a window size defined as ten minutes, and a representative value selection criterion defined as an average. The abbreviation criterion information may denote a rule which selects, as a representative value, a result obtained by calculating an average on a fixed window having a window size “ten minutes” in a time dimension to abbreviate traffic data.

Examples of learning criterion information capable of being applied to the traffic information prediction scenario may include a kind of data defined as validation data, a learning reliability condition defined as 0.15% or less, a learning reliability calculation criterion defined as an RMSE, and an early stop condition defined as 2,000 times or more. The learning criterion information may denote a rule where learning reliability of a traffic prediction model is calculated by using validation data, and in a learning process, when an RMSE of the learning reliability is 0.15% or less or the number of learning repetitions is 2,000 or more, learning stops.

Knowledge augmentation criterion information applied to the traffic information prediction scenario may include the number of changes of an abbreviation criterion within a range of five times, a change factor defined as a window size, a change range defines as five minutes, ten minutes, and fifteen minutes, the number of learning accumulations defined fifteen times or more, and a knowledge augmentation start condition defined as the number of times the abbreviation criterion is changed six times or more. The knowledge augmentation criterion information may denote a rule where when learning based on changing of the abbreviation criterion information is repeated five times or less, a fixed window size is set to three kinds [five minutes, ten minutes, fifteen minutes], the number of accumulations of a learning result being stored as a learning history is fifteen times or more, and the number of changes of the abbreviation criterion is six times or more, knowledge augmentation for optimizing the abbreviation criterion information is performed whenever the learning result is stored as the learning history.

The meta-optimizer 10 may provide the abbreviator 20 with the abbreviation criterion information applied to the traffic information prediction scenario. The abbreviator 20 may perform an abbreviation process of selecting a representative value by using windows “five minutes”, “ten minutes”, and “fifteen minutes” in a time dimension. The learner 30 may perform learning on data abbreviated by the abbreviator 20. The evaluator 40 may determine whether a learning result of the learning machine 30 satisfies a learning criterion defined in the abbreviation criterion information. For example, when an RMSE of learning reliability in ten minutes-unit abbreviation is 0.13%, the RMSE may satisfy a rule less than 0.15%, and thus, a corresponding learning result may be stored as a learning history, and a process based on a rule of the knowledge augmentation criterion information may be completed.

Schema information applied to the traffic information prediction scenario may include abbreviation criterion information when a data dimension is a space dimension or a meaning dimension. For example, in association with abbreviation criterion information about the space dimension, the abbreviator 20 may abbreviate traffic data by units of spaces such as such as a use zone (for example, a residential zone, a central commercial zone, etc.) or an administrative district (for example, si/gun/gu) to which a road where a driving speed has been measured belongs, and may calculate a prediction model by using abbreviation data abbreviated by units of spaces.

In detail, the meta-optimizer 10 may set an abbreviation criterion for pieces of vehicle speed data measured on a road located in a specific block, for considering the volume of traffic of an adjacent road. In this case, in predict a driving speed at a specific point, the meta-optimizer 10 may additionally use data obtained by measuring the volume of traffic of an adjacent administrative district, in addition to data obtained by measuring the volume of traffic of an administrative district to which the specific point belongs. In this case, the abbreviation criterion information may set a rule “(data dimension: space), (kind of window: fixed window), (window size: three blocks), and (representative value selection criterion: average speed)”. The rule may denote a data abbreviation process of selecting an average speed as a representative value by using a fixed window “three blocks” in a space dimension.

Moreover, the meta-optimizer 10 may set abbreviation criterion information obtained by combining of meaning information and time information. In this case, the abbreviation criterion information may include (data dimension: space), (abbreviation location: Jongno-gu), (window size: commercial zone), (data dimension: time), (abbreviation range: 08:00˜09:30), (kind of window: fixed window), (window size: ten minutes), (representative value selection criterion: average speed). Such a rule may denote a data abbreviation process of selecting an average speed as a representative value by using a fixed window “ten minutes” for a time window “08:00˜09:30” in a space defined as a meaning dimension corresponding to a commercial zone located in Jongno-gu.

As another application example of the data meta-scaling apparatus illustrated in FIG. 1, the data meta-scaling apparatus of FIG. 1 may be applied to a power consumption predicting service.

By suitably setting an abbreviation criterion, a missing value of the amount of used energy and noise may be removed, thereby generating good-quality used energy amount data.

In order to manage the demand for energy, it is required to measure data about the amount of power used by heating and cooling devices and lighting devices consuming power energy at certain time intervals to generate an accurate learning model for energy demand prediction at a future specific time. In this case, the amount of used power measured from an individual device shows an irregular use pattern due to an external cause such as meteorological changes and holding of a specific event, and moreover, a missing value can occur due to an error of equipment and refusal of a user to release data.

Therefore, in a case of using data abbreviation according to an embodiment of the present invention, some missing values of measurement data and noise can be removed by changing units of data abbreviation.

For example, when the abbreviation criterion information includes (data dimension: space), (abbreviation location: research building), (window size: third floor), (data dimension: time), (abbreviation range: 08:00˜19:00), (kind of window: fixed window), (window size: ten minutes), and (representative value selection criterion: maximum used power amount), the abbreviation criterion information may denote a data abbreviation process of selecting a maximum used power amount as a representative value within a range predetermined as a fixed window “ten minutes” with respect to a time window “08:00˜19:00” in a space defined as a meaning dimension corresponding to a third floor of a research building.

The meta-optimizer 10 may provide the abbreviator 20 with abbreviation criterion information applied to the power demand predicting service, and the abbreviator 20 may perform data abbreviation, based on the abbreviation criterion information. The learning machine 30 may perform learning on an assigned power demand prediction model, and the evaluator 40 may determine whether learning result information satisfies a learning criterion. In this case, when a learning result based on the learning result information satisfies the learning criterion, the learning result may be stored as a learning history, and a process based on the knowledge augmentation criterion information may be completed.

As another application example of the data meta-scaling apparatus illustrated in FIG. 1, the data meta-scaling apparatus of FIG. 1 may be applied to optimization of power generation efficiency of a wind power generation system.

As the application example, it is required to set a suitable abbreviation criterion for storing power generation amount data so as to optimize an angle control timing of a blade wing of a wind power generator according to the changes in wind direction and wind speed. In this case, the wind direction and the wind speed may be predicted by using a micro-meteorological wind prediction model. The micro-meteorological wind prediction model may apply various models such as a numerical prediction model, a machine learning prediction model, and a hybrid model configured by a combination of the numerical prediction model and the machine learning prediction model.

Various strategies and models may be provided for controlling an angle of a blade wing caused by the predicted changes in wind direction and wind speed, and in an embodiment of the present invention, the strategies and the models are not limited.

In an embodiment where the meta-scaling apparatus is applied to optimization of power generation efficiency of the wind power generation system, the meta-optimizer 10 may provide the abbreviator 20 with abbreviation criterion information associated with the amount of generated wind power, and the abbreviator 20 may perform data abbreviation, based on the abbreviation criterion information. The learning machine 30 may perform learning on an assigned generated wind power amount prediction model by using abbreviated data, and the evaluator 40 may determine whether a learning result of the learning machine 30 satisfies a learning criterion. In this case, when the learning result satisfies the learning criterion, the learning result may be stored as a learning history, and a process based on a rule of the knowledge augmentation criterion information may be completed.

In an embodiment of the present invention, a learning history may be accumulated and stored according to a rule based on knowledge augmentation criterion information, and when the learning history is sufficiently stored so as to satisfy the rule based on the knowledge augmentation criterion information, an abbreviation criterion may be optimized by analyzing the learning history, and continuous learning may be realized through a process of adding optimized abbreviation criterion information to schema information to update the schema information automatically.

Hereinafter, a process of obtaining an optimal abbreviation criterion for updating schema information will be described.

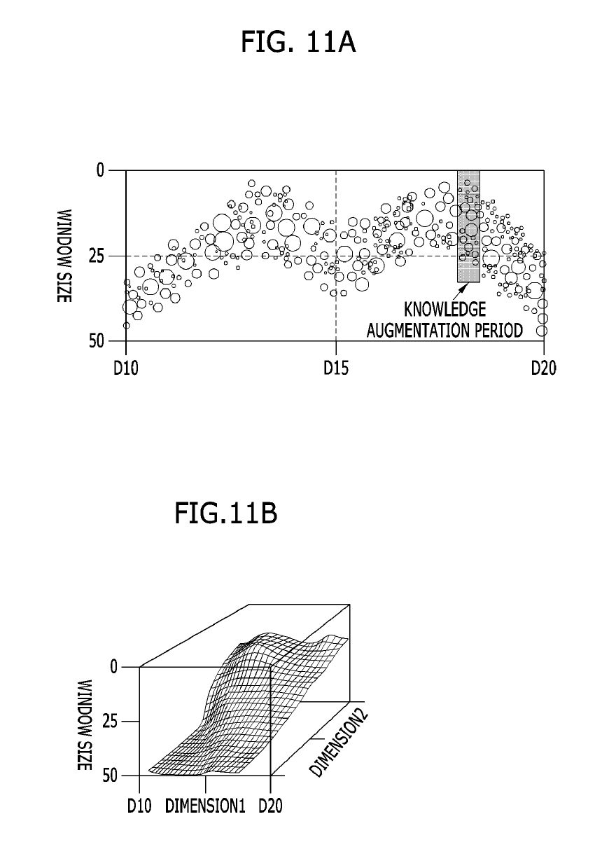

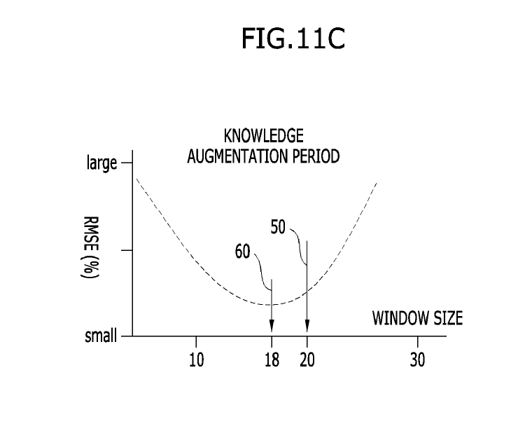

FIGS. 11A to 11C are diagrams schematically illustrating a knowledge augmentation process of obtaining an optimal abbreviation criterion according to an embodiment of the present invention. FIG. 11A two-dimensionally illustrates a result obtained by storing a learning history obtained through learning of a learning machine in one data dimension, based on various window sizes. FIG. 11B three-dimensionally illustrates a result obtained by storing a learning history obtained through learning of the learning machine in two data dimensions, based on various window sizes. FIG. 11C illustrates a process of obtaining an optimal window size by using a stored learning history to optimize abbreviation criterion information.

In FIG. 11A, a plurality of circles having various sizes on a plane defined by a horizontal axis and a vertical axis are illustrated, and each of the plurality of circles denotes reliability of a learning result. Here, the learning result is a result obtained by learning sensing data of a periodically repeated event.

Reliability of a learning result is relevant to a size of a circle. For example, as a size of a circle increases, reliability (or accuracy) of learning becomes higher.

A center of each of the plurality of circles is represented as a relative location based on a period on the horizontal axis and is represented as a location based on a window size based on abbreviation criterion information on the vertical axis. That is, the horizontal axis represents sensing values collected according to a sensing period of an event which is repeated in an arbitrary data dimension, and a range of the horizontal axis is defined as a minimum value “D10” and a maximum value “D20”.

The vertical axis represents a window size used in a data abbreviation process according to abbreviation criterion information, and the range of the vertical axis is defined as a minimum value “0” and a maximum value “50”.

In FIG. 11A, it may be assumed that when a sensing value is D15 and a window size is 25 in an arbitrary data dimension, reliability of a learning result is the highest.

In an embodiment of the present invention, the reliability of the learning result may be used as an indicator for evaluating suitability of data abbreviation, and in FIG. 11A, a window size where optimal data abbreviation is provided when a sensing value is D15 may be evaluated as 25. In this case, evaluation of an optimal data abbreviation condition is not limited to one dimension, and as illustrated in FIG. 11B, optimal data abbreviation may be evaluated for all data dimensions where the learning history is stored.

In an optimal data abbreviation condition for one data dimension, the optimal data abbreviation condition may be obtained through optimal evaluation illustrated in FIG. 11C with respect to a region illustrated as “knowledge augmentation period” in FIG. 11A. That is, in FIG. 11A, all learning histories included in the region illustrated as “knowledge augmentation period” in FIG. 11A may be extracted and may be aligned as illustrated in FIG. 11C.

A horizontal axis of FIG. 11C is the same as the vertical axis of FIG. 11A. That is, the horizontal axis of FIG. 11C represents a window size. A vertical axis of FIG. 11C denotes reliability (or accuracy) of a learning result represented as an RMSE.

If fitting is made on a two-dimensional (2D) curve in consideration of a size of the RMSE with respect to all of the learning histories included in the region illustrated as “knowledge augmentation period” in FIG. 11A, an optimal condition of a window for data abbreviation may be evaluated. That is, in FIG. 11C, a window size is 20 with respect to an abbreviation criterion “50” which is initially set, but an optimal window size is 18 with respect to an optimal abbreviation criterion on which fitting is made by using a learning history.

The meta-optimizer 10 may perform evaluation on an optimal data abbreviation condition using a learning history and may add new abbreviation criterion information, where a window size is set to 18, to schema information by using the evaluation. In a process of adding the schema information, intervention of a user or a user input is not needed, and thus, continuous learning for automatically updating the schema information may be performed.

In the data meta-scaling apparatus and method for continuous learning according to an embodiment of the present invention, a learning history may be sufficiently stored so as to satisfy a knowledge augmentation criterion, and then, whenever a new learning history is stored, continuous optimization of an abbreviation criterion may be performed according to the knowledge augmentation process described above with reference to FIGS. 11A to 11C.

As described above, through a process of updating the abbreviation criterion included in the schema information, a procedure of constructing the continuous learning may be automated, and optimization of the abbreviation criterion for abbreviating data may be automated through continuous knowledge augmentation.

The above-described data meta-scaling apparatus and method for continuous learning according to an embodiment of the present invention may be implemented as a program and stored in a recording medium, and then, may be loaded and executed by a processor.

A plurality of program modules (for example, the meta-optimizer, the abbreviator, the learning machine, and the evaluator) for realizing a function according to an embodiment of the present invention may be distributed over a network like a server farm, or may be embedded into a processor of a single computer device.

Moreover, the data meta-scaling apparatus and method for continuous learning according to an embodiment of the present invention may include a programmable processor, a computer, a multi-processor, or a multi-computer and may be embedded into all equipment, apparatuses, and machines for processing data.

Furthermore, the data meta-scaling apparatus for continuous learning according to an embodiment of the present invention may include, for example, a backend component such as a data server or a middleware component such as an application server. Alternatively, the data meta-scaling apparatus for continuous learning according to an embodiment of the present invention may further include a frontend component, such as a client computer including a graphics interface or a Web browser capable of interoperating with the elements described herein, or all of one or more combinations of the backend component, the middleware component, and the frontend component.

As described above, according to the embodiments of the present invention, in order to achieve optimal performance in the ML, a process of constructing continuous learning may be automated by performing a data abbreviation process on data, for which the ML is to be performed, in various dimensions, and optimization of the abbreviation criterion for data abbreviation may be automated through continuous knowledge augmentation.

Moreover, according to the embodiments of the present invention, knowledge augmentation criterion information which defines a criterion and a condition for updating abbreviation criterion information may be set with reference to schema information, data may be abbreviated by setting a plurality of different abbreviation criterion information based on the knowledge augmentation criterion information, and the abbreviated data may be evaluated by applying the abbreviated data to a plurality of different MLs in parallel, whereby a learning history based on various pieces of abbreviation criterion information may be generated and stored.

Moreover, according to the embodiments of the present invention, learning history information including input data information, schema information, learning model information, abbreviation criterion information, abbreviation data information, learning criterion information, learning data information, learning model information, learning result information, and knowledge augmentation criterion information may be accumulated and stored, and abbreviation criterion information may be optimized through knowledge augmentation for automatically setting optimal abbreviation criterion information, based on the stored learning history information.

Moreover, according to the embodiments of the present invention, since the data meta-scaling technology performs multidimensional abbreviation which enable expression of various kinds of data collected in IoT and IoE environments, the data meta-scaling technology may convert original data into data having another structure, and moreover, may add a new attribute to the original data to extend the original data, based on abbreviated information.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data meta-scaling method for continuous learning, the data meta-scaling method comprising:
setting, by a processor, abbreviation criterion information which defines a rule for abbreviating input data to be expressed in another attribute, learning criterion information which defines a rule for limiting learning on the abbreviation data and a rule for evaluating learning performance, and knowledge augmentation criterion information which defines a rule for optimizing the abbreviation criterion information;
abbreviating, by the processor, the input data to abbreviation data, based on the abbreviation criterion information;
performing, by the processor, learning on the abbreviation data to generate a learning model, based on the learning criterion information;
evaluating, by the processor, performance of the learning model to determine suitability of the abbreviation data, based on the learning criterion information; and
performing, by the processor, knowledge augmentation for updating the abbreviation criterion information according to a result of the suitability determination, based on the knowledge augmentation criterion information.

2. The data meta-scaling method of claim 1, wherein the setting comprises setting the abbreviation criterion information which defines a rule for abbreviating the input data expressed as a plurality of attributes to be expressed as at least one of the plurality of attributes.

3. The data meta-scaling method of claim 1, wherein the setting comprises, when the input data is expressed as a plurality of attributes, setting the abbreviation criterion information which includes information representing a data dimension defining one of the plurality of attributes, information representing a window defining a unit of sampling of the input data, information representing a kind of the window, information representing a size of the window, and information representing a criterion for selecting a representative value in the window.

4. The data meta-scaling method of claim 1, wherein the setting comprises setting the learning criterion information which includes information representing a kind of the input data, information representing a condition of learning reliability for evaluating performance of the learning model, information representing a method of calculating the learning reliability, and information representing an early stop condition of learning which limits number of repetitions of the learning on the abbreviation data.

5. The data meta-scaling method of claim 1, wherein the setting comprises setting the knowledge augmentation criterion information which includes information representing number of changes of the abbreviation criterion information, information representing a change factor of the abbreviation criterion information, information representing a change range of the change factor, and information representing number of accumulations of a learning history generated in a process of performing learning on the abbreviation data.

6. The data meta-scaling method of claim 5, wherein the change factor is information associated with a window defining a unit of sampling of the input data.

7. The data meta-scaling method of claim 6, wherein the information associated with the window comprises pieces of information representing a size of the window and an interval between windows.

8. The data meta-scaling method of claim 1, wherein the abbreviating comprises, when the input data is expressed as a plurality of attributes and the plurality of attributes are defined as a plurality of data dimensions, abbreviating the input data to abbreviation data through one of a first process of sampling the input data as a representative value of the input data in each of the plurality of data dimensions, a second process of changing the input data to at least one data dimension selected from among the plurality of data dimensions, and a third process including a combination of the first process and the second process.

9. The data meta-scaling method of claim 8, wherein the first process comprises:
a process of periodically sampling the input data as the representative value of the input data;
a process of aperiodically sampling the input data as the representative value of the input data;
a fixed window-based sampling process of, in a state where a plurality of windows defining a unit of sampling of the input data do not overlap each other, selecting the representative value in each of the plurality of windows; and
a moving window-based sampling process of, in a state where the plurality of windows overlap each other, selecting the representative value in each of the plurality of windows.

10. The data meta-scaling method of claim 1, wherein the performing of the knowledge augmentation comprises:
when learning reliability calculated for evaluating the performance of the learning model does not satisfy a condition prescribed in the rule, defined in the learning criterion information, for evaluating the learning performance, changing the abbreviation criterion information according to information representing a change factor, defined in the knowledge augmentation criterion information, of the abbreviation criterion information and a change range of the change factor; and
when performance of a learning model generated by performing learning on the abbreviation data abbreviated based on the changed abbreviation criterion information satisfies a condition prescribed in the learning criterion information, updating the changed abbreviation criterion information to optimal abbreviation criterion information.

11. A data meta-scaling apparatus for continuous learning, the data meta-scaling apparatus comprising:
a meta-optimizer setting abbreviation criterion information which defines a rule for abbreviating input data to be expressed in another attribute, learning criterion information which defines a rule for limiting learning on the abbreviation data and a rule for evaluating learning performance, and knowledge augmentation criterion information which defines a rule for optimizing the abbreviation criterion information;
an abbreviator abbreviating the input data to abbreviation data, based on the abbreviation criterion information;
a learning machine performing learning on the abbreviation data to generate a learning model, based on the learning criterion information; and
an evaluator evaluating performance of the learning model to determine suitability of the abbreviation data, based on the learning criterion information,
wherein the meta-optimizer performs knowledge augmentation for updating the abbreviation criterion information according to a result of the suitability determination, based on the knowledge augmentation criterion information.

12. The data meta-scaling apparatus of claim 11, wherein the meta-optimizer sets the abbreviation criterion information which defines a rule for abbreviating the input data expressed as a plurality of attributes to be expressed as at least one of the plurality of attributes.

13. The data meta-scaling apparatus of claim 11, wherein when the input data is expressed as a plurality of attributes, the meta-optimizer sets the abbreviation criterion information which includes information representing a data dimension defining one of the plurality of attributes, information representing a window defining a unit of sampling of the input data, information representing a kind of the window, information representing a size of the window, and information representing a criterion for selecting a representative value in the window.

14. The data meta-scaling apparatus of claim 11, wherein the meta-optimizer sets the learning criterion information which includes information representing a kind of the input data, information representing a condition of learning reliability for evaluating performance of the learning model, information representing a method of calculating the learning reliability, and information representing an early stop condition of learning which limits number of repetitions of the learning on the abbreviation data.

15. The data meta-scaling apparatus of claim 11, wherein the meta-optimizer sets the knowledge augmentation criterion information which includes information representing number of changes of the abbreviation criterion information, information representing a change factor of the abbreviation criterion information, information representing a change range of the change factor, and information representing number of accumulations of a learning history generated in a process of performing learning on the abbreviation data.

16. The data meta-scaling apparatus of claim 15, wherein the change factor is information associated with a window defining a unit of sampling of the input data.

17. The data meta-scaling apparatus of claim 11, wherein
when the performance of the learning model does not satisfy a condition prescribed in the rule for evaluating the learning performance, the meta-optimizer changes the abbreviation criterion information according to information representing a change factor, defined in the knowledge augmentation criterion information, of the abbreviation criterion information and a change range of the change factor, and
when performance of a learning model generated by performing learning on the abbreviation data abbreviated based on the changed abbreviation criterion information satisfies a condition prescribed in the learning criterion information, the meta-optimizer stores the changed abbreviation criterion information as the updated abbreviation criterion information in a storage unit to perform knowledge augmentation.
